(19) United States
(12) Patent Application Publication
(10) Pub. No.: US 2004/0021897 A1
(43) Pub. Date: Feb. 5, 2004

(54) System and method for remotely managing operations of a printing apparatus

(76) Inventor: Robert Simoneau, Chambly (CA)

Correspondence Address: BIRCH STEWART KOLASCH & BIRCH, PO BOX 747, FALLS CHURCH, VA, 22040-0747, US

(21) Appl. No.: 10/333,463

(22) PCT Filed: Jul. 19, 2001
(86) PCT No.: PCT/CA01/01048

(30) Foreign Application Priority Data
Jul. 21, 2000 (CA) 2314199

(51) Int. Cl. B41J 1/00

(52) U.S. Cl. 358/1.15; 399/1; 700/1

(57) ABSTRACT

A system and apparatus for remotely enabling or disabling the use of an apparatus such as a photocopy machine, wherein the photocopy machine is fitted with a means for counting the number of times the machine has operated, and for comparing that number with a pre-authorized maximum number, which pre-authorized number has been recorded following the receipt of a wireless signal from a wireless communication system, and wherein when the pre-authorized number has been reached, the system shuts down the use of the machine. The pre-authorized maximum number may be changed or updated through further signals from the wireless communication system.

The present invention relates to a system and a method for remotely managing operations of a printing apparatus. More particularly, it relates to a system for enabling operation of a pay-per-use printing apparatus such as a photocopier, a printer, a fax machine or any similar office equipment, through a wireless network. This invention may also have applications for computers, laptops, hand-held computers and generally any other type of electronic equipment.

Printing apparatuses which are useful in office environments are sometimes available for lease on a pay-per-use (or print-for-pay) basis. In this type of lease, a renter typically agrees to pay a predetermined amount for each use made of the apparatus. For example, in the case of a photocopier, a renter may pay in advance an amount to acquire the right to make a given number of photocopies. The number of pages is thus an important information to monitor and record.

Depending on the photocopiers, the number of copies may be read by a mechanical counter or by an electronic system, which tracks the maximum number of copy corresponding to what was paid in advance. Alternatively, the number of copies may be simply monitored and the count is recorded from time to time for billing purposes. In both cases, a technician or another person needs to be physically present to either input the appropriate information or record it.

There is thus a need for a system and a method for enabling operation of a pay-peruse printing apparatus through a wireless network, allowing to manage the operation of leased office equipment in a more effective way. In particular, there is a need for an after-market application which may enable the owner or operator of printing apparatus and other similar machines to retrofit them with an easy, inexpensive and convenient means of remotely controlling said apparatus by being able to disable, i.e. shut it off, at a distance. There is also a need to be able to enable, i.e. turn on, the apparatus from a distance, either at the beginning of a lease, after a maximum number of operations has occurred, or after any other event has occurred. For example, if the user initially paid for 10,000 copies, the system may be able to send a signal to the apparatus allowing said 10,000 copies. Once that number of copies has been made, the apparatus would be automatically disabled, i.e. would be turned off, and would no longer be able to make copies, without the need for any other intervention. Subsequently, the lessee may wish to purchase a further number of copies, and may do so from the owner of the apparatus, or from the operator or from any other party, following which, a signal may be sent through said wireless network to the apparatus allowing the additional number of copies. It is understood that additional copies may be purchased prior to the expiry of the initial number of copies. It is further understood that the system may comprise additional features to forward a message to the lessee that the maximum number of copies will soon be reached.

More particularly, the present invention relates to a system for managing operations of a printing apparatus, the system being characterized in that it comprises means for wirelessly receiving an encoded signal indicative of a pre-authorized number of prints; means for recording the pre-authorized number of prints; means for counting prints based on signals from the line supply to which the printing apparatus is connected; means for comparing the number of counted prints with the pre-authorized number; and means for issuing a signal indicative that the number of counted prints is within a preset range of the pre-authorized number of prints. As may be understood, the present invention may be directed to an event counting apparatus, using non invasive, plug in type of apparatus, which may be plugged into the power supply, or connected to the line voltage of the printing apparatus.

Therefore in accordance with a general aspect of the present invention there is provided for:

A system (10) for managing operations of a printing apparatus (12), the system (10) comprising:

means for receiving an encoded signal indicative of a pre-authorized number of prints;

means for recording the pre-authorized number of prints;

means for counting prints based on signals from the line supply to which the printing apparatus (12) is connected;

means for comparing the number of counted prints with the pre-authorized number; and

means for issuing a signal indicative that the number of counted prints is within a preset range of the pre-authorized number of prints.

Further, in accordance with an additional embodiment of the present invention, there is provided for a system for remotely managing the operation of an apparatus through a wireless communication system in order to enable and/or disable from a distance the operation of said apparatus,

the system comprising said apparatus,

a wireless communication system adapted to receive and send signals,

a disabler operatively connected to said apparatus,

said wireless communication system being able to receive signals from a remote party wishing to enable and/or disable said apparatus,

wherein said disabler is adapted to receive signals from said wireless communication system instructing said disabler to enable the operation of said apparatus for a number of pre-authorized uses, after which said disabler disables the operation of said apparatus until said enabler receives a new signal from said wireless communication system instructing said disabler to enable the operation of said apparatus for a further number of pre-authorized uses, wherein said disabler comprises:

a receiver adapted to receive signals from said wireless communication system,

a processor adapted to receive said signal from said receiver,

a current signature sensor connected to said apparatus' power supply, said sensor being adapted to analyze the electrical consumption of said apparatus to determine the frequency of operation of said apparatus, said sensor forwarding a message to said processor comprising the characteristics of each operation of said apparatus,

a switch, which upon receipt of instructions from said processor, enables and/or disables the operation of said apparatus,

said processor being adapted to track the number of operations of said apparatus and to compare said number of operations with a signal received by said receiver,

and wherein if said number of operations equals said signal, said processor forwards instructions to said switch to disable said apparatus, wherein said processor is adapted to receive new signals from said receiver,

said signals indicating an updated number of operations,

wherein following the receipt of said new signal, said processor instructs said switch to enable the operation of said apparatus, wherein said processor may be connected to a display window allowing the display thereon of the maximum number of operations and the number of actual operations.

These and other aspects and advantages of the present invention are described in or apparent from the following detailed description of a preferred embodiment made in conjunction with the accompanying figures, in which:

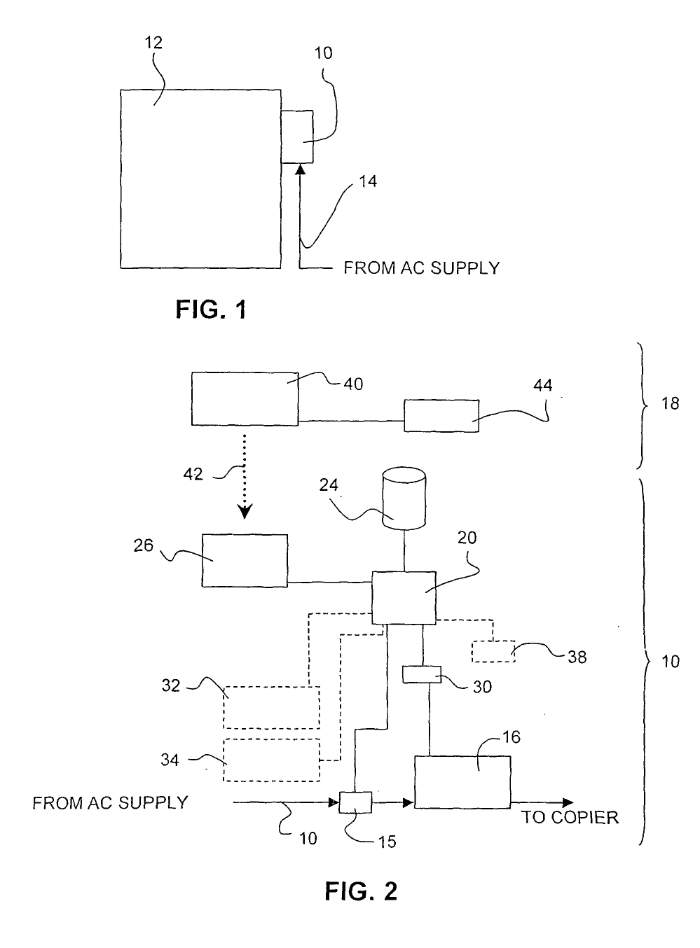

FIG. 1 is a schematic view of the exterior of a system installed on a printing apparatus.

FIG. 2 is a block diagram showing the internal components of the system illustrated in FIG. 1.

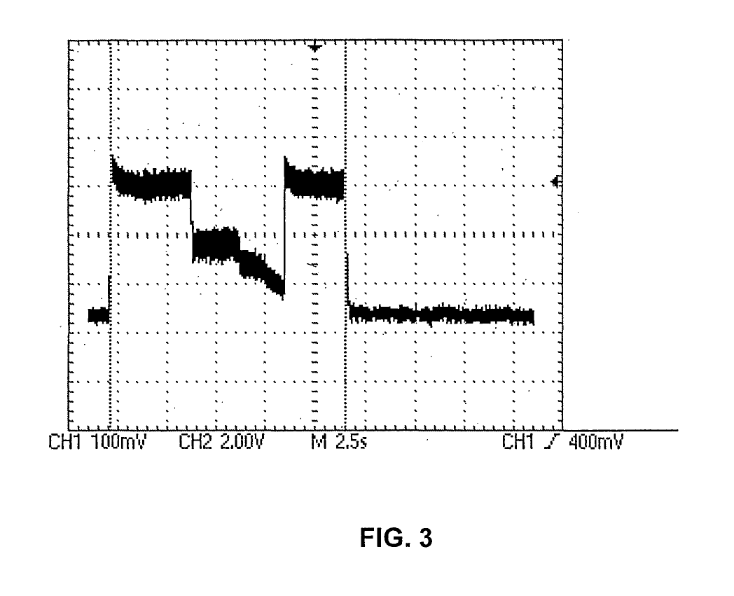

FIG. 3 is a graph showing an example of the current signature for a particular photocopier, as sensed by the system when the photocopier made a letter-size photocopy.

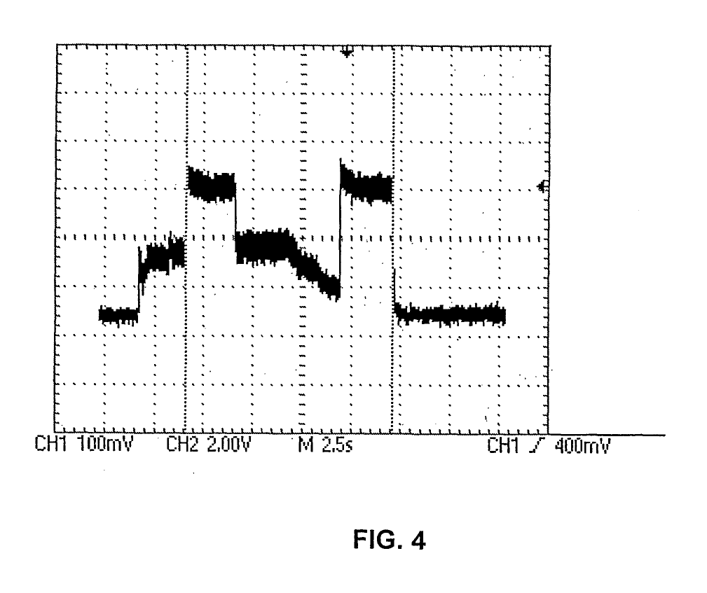

FIG. 4 is a graph similar to that of FIG. 3, showing an example of the current signature for the same photocopier when it made a legal-size photocopy.

Referring to FIG. 1, there is shown the exterior of a system (10) in accordance with a particular embodiment of the present invention. This system (10) is in the form of an independent unit that is plugged or otherwise electrically connected to a printing apparatus (12), preferably at the back thereof. It is also understood that the system (10) may be incorporated directly, i.e. mechanically and electrically into an apparatus (12), for example at the manufacturing facility of the apparatus (12).

The printing apparatus (12) may be any type of office equipment such as a photocopier, a printer, a fax machine or any similar equipment that may need to be remotely managed.

FIG. 1 shows the printing apparatus (12) being a photocopier. In that case, the system (10) may be installed in registry with the electrical socket located at the back of the apparatus (12). The system (10) comprises a corresponding socket that plugs directly into that of the printing apparatus (12). The system (10) is then screwed or otherwise attached to prevent removal thereof. In the case of screws, the screws can be installed from the interior of the system (10) and the cover of the system (10) is later closed using tamper-proof screws or any other mean for locking its cover. This will prevent someone from removing the system (10) and power the apparatus (12) using a direct connection from the AC supply. Instead, the system (10) is connected to the AC supply and the electrical power will be supplied to the printing apparatus (12) through the system (10).

Although the system (10) is preferably an independent and non-invasive unit, it is possible to integrate the components inside the printing apparatus (12) itself, either during the manufacturing process or using a retrofitting kit. Providing an independent unit has the advantage of being more simple and easy to install, thus avoiding the costs associated with modifying the printing apparatuses. Moreover, a same model may be designed for a variety of different printing apparatuses.

FIG. 2 illustrates the components of the system (10), as well as the wireless communication system (18) associated with the operation of the system (10).

Because the system (10) needs to maintain a control on the operation of the printing apparatus, a switch (15) is provided to turn off the apparatus (12) if credits for its use are no longer available. The apparatus (12) can also be switched off if maintenance is required after a predetermined number of uses and the operators failed to make the appropriate service call.

A current signature sensor (16) is mounted in-line with the power supply line. This sensor (16) monitors the electrical power supplied to the apparatus in order to extract useful information when the apparatus is operating. Monitoring the variations in the current supplied to the apparatus gives a very precise indication of when the apparatus is working and how many times it operates. Following a previous calibration to obtain the current signature, it is also possible to know, for instance, whether the apparatus is working with paper in letter format or paper in legal format if the apparatus is a photocopier. Alternatively, the current sensor (16) may be replaced or combined with by a voltage sensor. However, the latter is less precise since the voltage usually fluctuates at the supply line.

The system (10) comprises a processor (20) to manage the operation thereof. The processor (20) receives signals from the current signature sensor (16) through an analog-to-digital converter (30). The processor (20) conducts an analysis of the signature of the signal using pre-recorded information stored in a memory, for instance a memory module (24) to which it is connected. The processor (20) later updates the information in a memory where statistics related to the use of the printing apparatus (12) are recorded. This update may be in the form of an addition or a subtraction, depending on how the count of the pre-authorized or purchased number of uses is tracked.

The processor (20) and/or any pre-recorded information may be changed or otherwise updated from time to time, using for example an I.O. socket 38. It is also possible to provide the system (10) with a display window (32) or any visual indicator to display information such as the status of the system (10), the number of pre-purchased copies available, etc. Similarly, buttons or even a keyboard (34) can be used to access the system (10), for instance for obtaining more statistics, updating a parameter, controlling access using identification numbers or cards, etc.

The system (10) also comprises a receiver (26) which is also connected to the processor (20). The receiver (26) is designed to receive a signal from the wireless communication network (18), namely an emitter (40). The emitter (40) is preferably an antenna of a very large global network and operated through a third party. For instance, in the latter case, this network could use frequencies at 27 kHz, 58 kHz, 8.2 MHz, or 144-152 MHz. It could also be operating in the range of 925-950 MHz. The final frequency or range of frequencies and method chosen would depend upon the application, the commercial agreement to be established with a service provider, as well as the preferred characteristics of wave propagation.

In use, the party, i.e. the company in charge of managing operations of the printing apparatus (12) would be in communication with a server (44). The server (44) is operated by the manager of the wireless communication network. Whenever a client wishes to purchase a number of uses of the printing apparatus (12), it contacts the operation manager, for example by phone or through a web site. He or she then makes the appropriate transaction and upon completing the transaction, the party, i.e. the company in charge of managing operations of the printing apparatus (12) would send an authorization to the central server (44). The server (44) receives the authorization and sends a corresponding command signal to broadcast in global network or in a specific port thereof. In all cases, the exchange of information with systems (10) is carried out in a secure manner using encryption and authentication methods to prevent any fraudulent use thereof. The signal is tailored for the individual system (10).

Upon receiving a signal, at the receiver (26), the processor (20) of the system (10), decodes it and analyses the data against a predetermined criteria to determine if a command signal should be generated. The format used by the decoder may be, for instance, POCSAG (post office codes standardization advisory), ERMES (European radio message system), FLEX or any other. The sample bit rate used preferably varies between 2400 bps to 6400 bps. The processor (20) may also incorporate checksum error checking routines to ensure integrity of the data being processed. If the processor (20) determines that the command signal is intended to its corresponding system (10), it records the pre-authorized number of prints in its memory module (24).

Therefore, unless proper authorization is obtained, someone wishing to use the printing apparatus (12) will be denied benefit of use unless payment or payment arrangements are made in advance.

The system (10) comprised means for issuing a signal indicative that the number of counted prints is within a preset range of the pre-authorized number of prints. This may be done in a number of ways, such as through the display window (32) or an audible signal. Alternatively, it could be a signal sent to the printing apparatus (12) and displayed in a display window thereof. The preset range can be anywhere from 0 to a given number or percentage remaining available.

FIGS. 3 and 4 are example of the current signature sensed by the current sensor (16). The printing apparatus was, for example, a MINOLTA TM Digital Photocopier Model DI-181. FIG. 3 shows the current sensed for a letter-size photocopy. FIG. 4 shows the current sensed for a legal-size photocopy. These figures show differences between the two current signatures, i.e. in the vertical dotted lines. These graphs are then digitalized through the analog-to-digital converter (30), and the resulting signal is analyzed by the processor (20) to determine the type of photocopy, using information stored in the memory. A client may then be charged more for a legal-size copy than a letter-size one. For instance, a legal-size copy may be counted as the equivalent of a 1.2 letter-size copy.

Once the maximum number of prints is reached, the printing apparatus (12) is preferably turned off. Alternatively, the system (10) can send a deactivation signal to the printing apparatus (12) itself to deny use of the apparatus unless a number of pre-authorized number of prints is purchased once again.

The invention is not limited to the described embodiment and encompasses any alternative embodiments within the limits defined by the appended claims.

What is claimed is:

1. A system (10) for managing operations of a printing apparatus (12), the system (10) comprising:
means for receiving an encoded signal indicative of a pre-authorized number of prints;
means for recording the pre-authorized number of prints;
means for counting prints based on signals from the line supply to which the printing apparatus (12) is connected;
means for comparing the number of counted prints with the pre-authorized number; and
means for issuing a signal indicative that the number of counted prints is within a preset range of the pre-authorized number of prints.

2. A system for remotely managing the operation of an apparatus through a wireless communication system in order to enable and/or disable from a distance the operation of said apparatus,
the system comprising said apparatus,
a wireless communication system adapted to receive and send signals,
a disabler operatively connected to said apparatus,
said wireless communication system being able to receive signals from a remote party wishing to enable and/or disable said apparatus,
wherein said disabler is adapted to receive signals from said wireless communication system instructing said disabler to enable the operation of said apparatus for a number of pre-authorized uses, after which said disabler disables the operation of said apparatus until said enabler receives a new signal from said wireless communication system instructing said disabler to enable the operation of said apparatus for a further number of pre-authorized uses.

3. The system of claim 2 wherein said disabler comprises
a receiver adapted to receive signals from said wireless communication system,
a processor adapted to receive said signal from said receiver,
a current signature sensor connected to said apparatus' power supply, said sensor being adapted to analyze the electrical consumption of said apparatus to determine the frequency of operation of said apparatus, said sensor forwarding a message to said processor comprising the characteristics of each operation of said apparatus,
a switch, which upon receipt of instructions from said processor, enables and/or disables the operation of said apparatus,
said processor being adapted to track the number of operations of said apparatus and to compare said number of operations with a signal received by said receiver,
and wherein if said number of operations equals said signal, said processor forwards instructions to said switch to disable said apparatus.

4. The system of claim 3 wherein said processor is adapted to receive new signals from said receiver,
said signals indicating an updated number of operations,
wherein following the receipt of said new signal, said processor instructs said switch to enable the operation of said apparatus.

5. The system of claim 4 wherein said processor may be connected to a display window allowing the display thereon of the maximum number of operations and the number of actual operations.
